(19) United States
(12) Patent Application Publication
(10) Pub. No.: US 2021/0295016 A1
(43) Pub. Date: Sep. 23, 2021

(54) LIVING BODY RECOGNITION DETECTION METHOD, MEDIUM AND ELECTRONIC DEVICE

(71) Applicant: BEIJING SANKUAI ONLINE TECHNOLOGY CO., LTD, Beijing (CN)

(72) Inventor: Pengfei YAN, Beijing (CN)

(21) Appl. No.: 17/258,423

(22) PCT Filed: Jun. 18, 2019
(86) PCT No.: PCT/CN2019/091723

§ 371 Date: Jan. 6, 2021

(30) Foreign Application Priority Data
Jul. 6, 2018 (CN) 201810734833.9

(51) Int. Cl. G06K 9/00; G06K 9/46; G06K 9/62

(52) U.S. Cl. CPC G06K 9/00281; G06K 9/00906; G06K 9/6215; G06K 9/4671; G06K 9/00744

(57) ABSTRACT

A living body recognition detection method is provided, including: acquiring a plurality of frames of images of a target object at different positions relative to a pick-up camera; extracting a plurality of key points on each frame of image in the plurality of frames of images; respectively calculating distances between the key points on each frame of image, and calculating a plurality of ratios according to the calculated distances of each frame of image; and analyzing changes of the plurality of ratios for the plurality of frames of images, and determining whether the target object is a living object or not according to the changes of the plurality of ratios.

This application is a national stage of an international application No. PCT/CN2019/091723, filed on Jun. 18, 2019, and entitled “LIVING BODY RECOGNITION DETECTION METHOD, APPARATUS, MEDIUM AND ELECTRONIC DEVICE.” The international application claims priority to Chinese Patent Application No. 201810734833.9, entitled “Living body recognition detection method, apparatus, medium and electronic device” and filed on Jul. 6, 2018. Both applications are incorporated herein by reference in their entirety.

### TECHNICAL FIELD

This application relates to the technical field of biological recognition, and specifically, to a living body recognition detection method, medium and electronic device.

### BACKGROUND

With the development of network technologies, face recognition technology is being applied to more and more fields, such as online payment, online banking, and security systems.

In order to prevent malicious users from using the captured target face photos to complete face recognition, which leads to the problem of poor security of the face recognition system, existing face recognition systems have been equipped with the process of living body recognition and verification.

The information disclosed in the Related Art section is merely used for enhancing the understanding of the background of this application, and therefore, may include information that does not constitute related technologies known to those of ordinary skill in the art.

### SUMMARY

An objective of embodiments of this application is to provide a living body recognition detection method, medium and electronic device.

Other features and advantages of this application become obvious through the following detailed descriptions, or may be learned partially by the practice of this application.

According to an aspect of the embodiments of this application, a living object recognition method is provided, including:

acquiring a plurality of frames of images of a target object at different positions relative to a pick-up camera;

extracting a plurality of key points on each frame of image in the plurality of frames of images;

respectively calculating distances between the key points on each frame of image, and calculating a plurality of ratios of each frame of image according to the calculated distances of each frame of image; and

analyzing changes of the plurality of ratios for the plurality of frames of images, and determining whether the target object is a living object or not according to the changes of the plurality of ratios.

According to yet another aspect of the embodiments of this application, a non-volatile computer readable medium is provided, storing a computer program therein, where when executed by a processor, the program implements a living object recognition method, the method including:

acquiring a plurality of frames of images of a target object at different positions relative to a pick-up camera;

extracting a plurality of key points on each frame of image in the plurality of frames of images;

respectively calculating distances between the key points on each frame of image, and calculating a plurality of ratios of each frame of image according to the calculated distances of each frame of image; and

analyzing changes of the plurality of ratios for the plurality of frames of images, and determining whether the target object is a living object or not according to the changes of the plurality of ratios.

According to yet another aspect of the embodiments of this application, an electronic device is provided, including: one or more processors; and a storage apparatus configured to store one or more programs that, when executed by the one or more processors, cause the one or more processors to implement the following operations:

acquiring a plurality of frames of images of a target object at different positions relative to a pick-up camera;

extracting a plurality of key points on each frame of image in the plurality of frames of images;

respectively calculating distances between the key points on each frame of image, and calculating a plurality of ratios of each frame of image according to the calculated distances of each frame of image; and

analyzing changes of the plurality of ratios for the plurality of frames of images, and determining whether the target object is a living object or not according to the changes of the plurality of ratios.

It should be understood that the foregoing general descriptions and the following detailed descriptions are only exemplary, and cannot limit this application.

### BRIEF DESCRIPTION OF THE DRAWINGS

The accompanying drawings, which are incorporated herein and constitute a part of this specification, illustrate embodiments consistent with this application and, together with the specification, serve to explain the principles of this application. Apparently, the accompanying drawings in the following description show only some embodiments of this application, and a person of ordinary skill in the art may still derive other drawings from these accompanying drawings without creative efforts. In the accompanying drawings:

FIG. 1 schematically shows a flowchart of a living body recognition detection method according to an embodiment of this application.

FIG. 2 schematically shows a flowchart of a living body recognition detection method according to another embodiment of this application.

FIG. 3 schematically shows a flowchart of a living body recognition detection apparatus according to an embodiment of this application.

FIG. 4 is a schematic structural diagram of a computer system adapted to implement an electronic device according to an embodiment of this application.

### DETAILED DESCRIPTION

At present, the examples of implementations are described comprehensively with reference to the accompanying drawings. However, the exemplary embodiments can be implemented in various forms and are not be understood as being limited to examples herein. Conversely, the examples of implementations are provided to make the technical solution of this application more comprehensive and complete, and comprehensively convey the idea of the examples of the implementations to a person skilled in the art.

In addition, the features, structures, or characteristics described in this application may be combined in one or more embodiments in any appropriate manner. In the following descriptions, a plurality of specific details are provided to give a comprehensive understanding of the embodiments of this application. However, a person skilled in the art will realize that the technical solution of this application can be practiced without one or more specific details, or other methods, components, apparatuses, steps and the like can be adopted. In other cases, public methods, apparatuses, implementations or operations are not shown or described in detail to avoid blurring aspects of this application.

The block diagram shown in the accompanying drawings is merely a functional entity and does not necessarily correspond to a physically independent entity. That is, these functional entities can be implemented in the form of software, in one or more hardware modules or integrated circuits, or in different networks and/or processor apparatuses and/or microcontroller apparatuses.

The flowchart shown in the accompanying drawings is merely exemplary description, and does not necessarily include all contents and operations/steps, nor does it have to be executed in the order described. For example, some operations/steps may be further decomposed, while some operations/steps may be merged or partially merged, so the actual execution order may change according to the actual situation.

In related living body recognition technologies, recognition can be performed by determining whether the user completes a specified interaction action, such as blinking, opening mouth, raising head, etc. If the user completes the specified action within a specified time, the recognition may be deemed as successful. However, malicious attackers can record in advance a video of the user performing the above actions, and use the video to trick the recognition system, resulting in poor security of the recognition system. There are also some living body recognition technologies that use a 3D sensor to obtain the user's 3D information for recognition. Point depth information of the photo or video is consistent, but point depth information of the face of a living body is inconsistent. By making use of this point, the problem that an attacker uses a video to attack the system can be overcome. This method, however, requires the support of an additional sensor device, and cannot be widely used because such sensor devices are not popular in mobile phones, computers and other terminal devices.

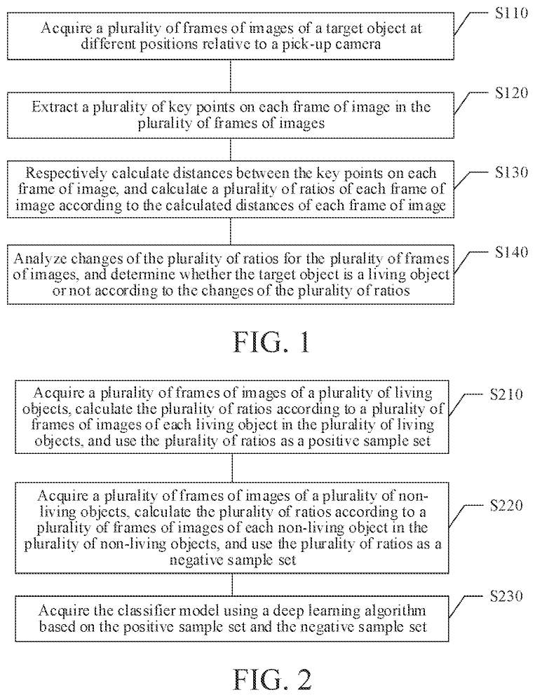

Based on this, an example embodiment of this application first provides a living body recognition detection method. As shown in FIG. 1, the method may include steps S110, S120, S130 and S140. Here:

Step S110, acquiring a plurality of frames of images of a target object at different positions relative to a pick-up camera;

Step S120, extracting a plurality of key points on each frame of image in the plurality of frames of images;

Step S130, respectively calculating distances between the key points on each frame of image, and calculating a plurality of ratios of each frame of image according to the calculated distances of each frame of image; and

Step S140, analyzing changes of the plurality of ratios for the plurality of frames of images, and determining whether the target object is a living object or not according to the changes of the plurality of ratios.

In comparison with the scheme of acquiring the user's three-dimensional information with the 3D sensor for recognition, the living body recognition detection method in this example embodiment acquires the image with the pick-up camera, and does not require any additional sensor, which can reduce the resources occupied and reduce the costs; moreover, the limitation on whether a sensor is disposed on the terminal device is avoided, which improves the flexibility and usability.

Compared with the scheme that requires the user to complete the specified action within the specified time, the live recognition detection method in this example embodiment can accurately identify the situation that the malicious attacker uses the pre-recorded video of the user performing the specified action, and prevent the malicious attacker from passing the recognition without requiring the user to make multiple specified actions, which simplifies the user's operation, and makes the interaction with the user simple, thus reducing the recognition time and improving the recognition efficiency.

To sum up, according to the living body recognition detection method in this example embodiment, by using a pick-up camera to acquire a plurality of frames of images of a target object at different positions relative to the pick-up camera, no additional device is required, so the resources occupied can be reduced, thus reducing the costs; meanwhile, the flexibility and usability of the living object recognition system are improved; besides, by extracting a plurality of key points on each frame of image; calculating distances between the key points, and respectively calculating a plurality of ratios of each frame of image according to the calculated distances of each frame of image; and analyzing changes of the ratios for the plurality of frames of images, and determining whether the target object is a living object or not, attackers can be prevented from using an image or video of the target object to attack the recognition system, thus improving the security of the recognition system; also, the interaction with the user is simple, so the recognition time can be reduced and the recognition efficiency can be improved; furthermore, user experience can be improved.

Next, the steps of the living body recognition detection method in this exemplary embodiment will be described in more detail by referring to FIG. 1 to FIG. 2.

Step S110, acquiring a plurality of frames of images of a target object at different positions relative to a pick-up camera.

The camera can provide the functions of taking photos or recording videos, capturing images, etc., and can be applied to various terminal devices, such as mobile phones, computers, ATMs (automatic teller machines), etc. In addition, cameras can be used in various recognition systems, for example, face recognition system, vehicle license plate recognition system, visual recognition system, etc. In this embodiment, a face recognition system is taken as an example.

In this embodiment, the pick-up camera can acquire the plurality of frames of images of the target object at the different positions relative to the pick-up camera by shooting the target object multiple times, i.e., when the camera captures an image, the relative positions of the target object and the camera can change. The position of the target object can be changed when the position of the camera remains unchanged, or the position of the camera can be changed when the target object the position remains unchanged. For example, during capturing images of the target object, the camera can be adjusted to telescope, rotate or move otherwise, or the target object can be moved forward, backward, leftward or rightward. The plurality of frames of images may be a plurality of frames of images captured in multiple times in the process where the relative positions of the target object and the camera can change. For example, the plurality of frames of images may be a plurality of frames of images captured in multiple times in the process where the position of the target object changes relative to the camera, or may be obtained by capturing one or more frames of images for each displacement of the camera while the position of the target object remains unchanged. Optionally, a reference number of frames of images of the target object at different distances to the camera may further be set. That is to say, when the target object is at different distances to the camera, images are respectively captured, and the total number of images captured is ensured to be the reference number. For example, the camera can capture the reference number of frames of images of the target object from far to near or from near to far. The reference number can be set according to practical requirements, for example, 5 frames, 8 frames, etc.

In addition, the pick-up camera can also acquire a dynamic image of the target object at a changing position relative to the camera. That is to say, in the process where the relative positions of the target object and the camera can change, the camera can record the changing process of the position of the target object to obtain a dynamic image. After the dynamic image is obtained, the dynamic image can be divided according to reference time periods, and the reference number of frames of images can be extracted. That is to say, a reference number of reference time periods is set, and according to a time point of each frame of image in the dynamic image, one frame of image is extracted from each reference time period in the dynamic image, thus obtaining the reference number of frames of images.

When one frame of image is extracted from the reference time period, any frame of image, the time point of which in the dynamic image belongs to the reference time period can be extracted; or an image, the time point of which in the dynamic image is equal to a starting time point of the reference time period can be extracted; or other images in the reference time period can be extracted.

In addition, the reference number of reference time periods can have the same time length, and the reference number of reference time periods can be continuous, i.e., an end time point of one reference time period is a starting time point of a next reference time period.

For example, a 10-second long dynamic image is obtained. If the reference number is 5, then an image at 2 second, an image at 4 second, an image at 6 second, an image at 8 second and an image at 10 second can be extracted respectively, to constitute the plurality of frames of images of the target object.

Furthermore, in order to obtain the plurality of frames of images of the target object at the different positions relative to the pick-up camera, in this example embodiment, a detection box can be used to prompt the user that an image of the target object appears in the detection box, and the size of the detection box can be changed when the camera captures images, so as to prompt the user to change the distance of the target object relative to the camera, so as to obtain the plurality of frames of images of the target object.

The farther away a person is from the camera, the smaller the image of the person in the photo taken. When the size of the detection box changes, the distance between the target object and the camera can be changed accordingly in order to make the image of the target object appear in the detection box. In this manner, the images of the target object at different positions relative to the pick-up camera can be obtained.

Step S120, extracting a plurality of key points on each frame of image in the plurality of frames of images.

In this exemplary embodiment, a plurality of key points on each frame of image in the plurality of frames of images may be extracted after the plurality of frames of images is obtained.

For example, key point information on each frame of image in the plurality of frames of images can be extracted. The key point information of the image can be information about facial parts, and may also be contour information, for example, eye, nose, mouth or face contour, etc. The key point information can be acquired according to an ASM (Active Shape Mode) algorithm or a deep learning method. Definitely, according to practical situations, the key point information can also be extracted using other methods, for example, a CPR (Cascaded Pose Regression) method, etc.

For each frame of image, the key point information on said frame of image is extracted, so that at least one key point on said frame of image can be determined, and information about each key point can be determined, including the part to which each key point belongs, the position of each key point on said frame of image, and so on.

Step S130, respectively calculating distances between the key points on each frame of image, and calculating a plurality of ratios of each frame of image according to the calculated distances of each frame of image.

In this exemplary embodiment, the distances between the key points may be a distance between any two key points on the same frame of image. The distance between any two key points is determined by the positions of said two key points on the same frame of image. Optionally, on each frame of image, a distance from a pupil point to a nasal tip point may be used as a first distance, a distance from a pupil point to a mouth corner point may be used as a second distance, and a distance from a mouth corner point to a nasal tip point may be used as a third distance.

In addition, for each frame of image, the distances between the key points can be calculated using the above-mentioned method, and a plurality of ratios can further be calculated according to the calculated distances. The ratio can be obtained from a ratio between any two distances after the distances between the key points are calculated. Optionally, a pupil distance between two eyes on each frame of image may be acquired, and for the same frame of image, ratios of the first distance, the second distance and the third distance to the pupil distance of said frame of image are respectively calculated, so as to obtain the plurality of ratios. Meanwhile, for the ease of description, the ratio of the first distance to the pupil distance may be used as the first ratio, the ratio of the second distance to the pupil distance may be used as the second ratio, and the ratio of the third distance to the pupil distance may be used as the third ratio. For each frame of image, the first ratio, the second ratio and the third ratio can be obtained.

Optionally, for the same frame of image, the plurality of ratios may also be obtained by calculating a ratio of the first distance to the second distance, a ratio of the second distance to the third distance and a ratio of the first distance to the third distance. Or the plurality of ratios is calculated using other methods.

Step S140, analyzing changes of the plurality of ratios for the plurality of frames of images, and determining whether the target object is a living object or not according to the changes of the plurality of ratios.

In this exemplary embodiment, for each ratio, the ratio of each frame of image in the plurality of frames of images is compared, and the change of the value of the ratio in each frame of image in the plurality of frames of images is analyzed, to obtain a change rule of the ratio.

Optionally, the change of the value of the first ratio in each frame of image in the plurality of frames of images can be analyzed respectively. That is to say, the first ratio of the first frame of image in the plurality of frames of images may be compared with the first ratio of the second frame of image, the first ratio of the third frame of image, and so on, until the first ratio of the last frame of image, to analyze the change of the value of the first ratio. The second ratio and the third ratio can also be analyzed using the same method.

Whether the target object is a living object or not is determined according to whether the change rules of the values of the plurality of ratios among the plurality of frames of images comply with change rules of the plurality of ratios of the living object. Optionally, the step of acquiring the change rules of the plurality of ratios of the living object may include: acquiring a plurality of frames of images of the living object at different positions relative to the camera, extracting a plurality of key points of each frame of image in the plurality of frames of images, calculating distances between the key points, respectively calculating a plurality of ratios of the living object according to the calculated distances of each frame of image, and analyzing changes of the plurality of ratios. For a certain number of living objects, changes of the plurality of ratios of the certain number of living objects may be analyzed using various algorithms, so as to find a change rule of the plurality of ratios of the living objects.

Whether the target object is a living object or not can be determined according to whether the change rule of the plurality of ratios of the target object complies with a change rule of a plurality of ratios of a living object.

Or, whether the target object is a living object or not can also be determined according to whether the value of each ratio in the plurality of ratios is within a certain range of the ratio corresponding to a living object. In addition, a change rule of a plurality of ratios of a living object, for example, a change rule of a plurality of ratios of a face of a living object, may be analyzed, or a change rule of a plurality of ratios of a non-living object may be analyzed, a ratio change threshold may be set according to the change rule of the plurality of ratios, and it is determined whether a change of the plurality of ratios of the target object is less than or greater than the threshold, so as to determine whether the target object is a living object or not.

For example, in comparison with an image or video, a face is closer to a cylinder, so the closer the camera is to the face, the larger the deformation of the image captured is; while the distance between the camera and an image or video which is planar does not cause deformation of the image captured. Therefore, a change rule of the plurality of ratios of the image or video is different from that of the plurality of ratios of the face. By analyzing the change rule of the plurality of ratios of the living object, the change rule of the plurality of ratios can be used during the recognition of the target object, i.e., the difference between a cylinder and a planar object is taken into consideration, so the problem that an attacker uses a photo or video to attack can be overcome.

In addition, the face is not exactly the same as a cylinder. The surface of a cylinder is smooth, but facial parts of the face are uneven, e.g., the nose tip is protruding, the eye socket is recessed, etc. Such characteristics make the deformation of the face follow a certain rule. Therefore, by analyzing the change rule of the plurality of ratios of the living object, the change rule of the plurality of ratios can be used during the recognition of the target object, i.e., the difference between a real human face and a cylinder is taken into consideration, so the problem that an attacker bends a photo into a cylinder to attack can be overcome.

Further, in order to more accurately determine whether the target object is a living object or not according to the change of the plurality of ratios, this example embodiment further includes steps S210, S220 and S230, as shown in FIG. 2. Here:

Step S210, acquiring a plurality of frames of images of a plurality of living objects, calculating the plurality of ratios according to a plurality of frames of images of each living object in the plurality of living objects, and using the plurality of ratios as a positive sample set.

In this exemplary embodiment, the living object may be a real user to be recognized. The real user can perform various interaction operations with the recognition system. For example, when the user opens an account at a bank, registers an online banking service, or binds a bank card on a platform, recognition and verification by the recognition system are required, so as to ensure the security of property of the user. Taking the living object as a sample, a plurality of frames of images of the living object is obtained according to step S110, and a plurality of ratios obtained by performing processing in the above-mentioned steps S120 and S130 on the obtained plurality of frames of images can be used as a positive sample set. That is to say, a camera can be used to capture a plurality of frames of images of a living object at different positions relative to the camera, a plurality of key points of each frame of image in the plurality of frames of images is extracted, distances between the key points are calculated, and a plurality of ratios of each frame of image is calculated according to the calculated distances of each frame of image, so the plurality of ratios can be used as a positive sample set.

Step S220, acquiring a plurality of frames of images of a plurality of non-living objects, calculating the plurality of ratios according to a plurality of frames of images of each non-living object in the plurality of non-living objects, and using the plurality of ratios as a negative sample set.

In this exemplary embodiment, the non-living object may be an object which is not a real user, e.g., a picture, video, electronic device, etc. Optionally, the non-living object may be a planar object or cylindrical object. Taking the non-living object as a sample, a plurality of frames of images of the non-living object can be obtained according to step S110. A plurality of ratios corresponding to the non-living object can be obtained according to the above-mentioned steps S120 and S130, and the obtained plurality of ratios is used as a negative sample set. That is to say, a camera can be used to capture a plurality of frames of images of a non-living object at different positions relative to the camera, a plurality of key points of each frame of image in the plurality of frames of images is extracted, distances between the key points are calculated, and a plurality of ratios of each frame of image is calculated according to the calculated distances of each frame of image, so the plurality of ratios can be used as a negative sample set.

Step S230, acquiring the classifier model using a deep learning algorithm based on the positive sample set and the negative sample set.

The classification result of the sample can be acquired directly according to the classifier model, so that an analysis effect of the ratios can be acquired rapidly and efficiently. In this exemplary embodiment, the positive sample set and the negative sample set obtained in step S210 and step S220 can be used as training sets for the classifier model to train the classifier model. The trained classifier model can map any sample data to one of given categories. The classifier model can be trained based on a deep learning algorithm, or may also be trained using other algorithms such as a logistic regression algorithm

Further, after the above-mentioned classifier model is obtained, in step S140, the plurality of ratios can be input into the classifier model to obtain a classification result, and it can be determined whether the target object is a living object or not according to the classification result. In this exemplary embodiment, if the classification result is a positive class, it can be determined that the target object is a living object; if the classification result is a negative class, it can be determined that the target object is a non-living object. In addition, when the target object is determined as a living object, a prompt can further be provided to prompt that the user passes the recognition; when the target object is determined as a non-living object, a prompt can further be provided to prompt that the user fails in the recognition.

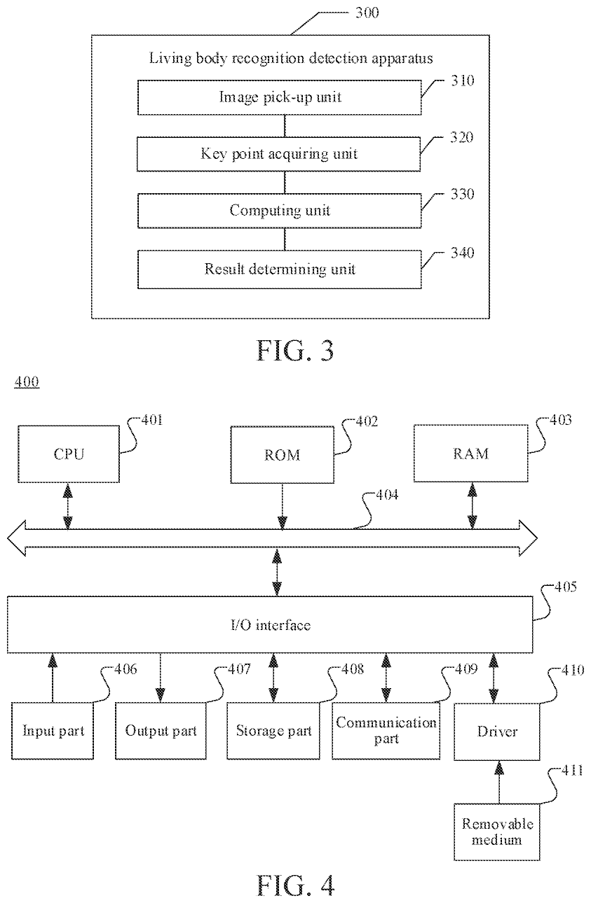

The following describes apparatus embodiments of this application, and the apparatus embodiments can be used for performing the above-mentioned living body recognition detection method of this application. As shown in FIG. 3, the living body recognition detection apparatus 300 may include:

an image pick-up unit 310, configured to acquire a plurality of frames of images of a target object at different positions relative to a pick-up camera;

a key point acquiring unit 320, configured to extract a plurality of key points on each frame of image in the plurality of frames of images;

a computing unit 330, configured to respectively calculate distances between the key points on each frame of image, and calculate a plurality of ratios of each frame of image according to the calculated distances of each frame of image; and

a result determining unit 340, configured to analyze changes of the plurality of ratios for the plurality of frames of images, and determine whether the target object is a living object or not according to the changes of the plurality of ratios.

In an exemplary embodiment of this application, the result determining unit 340 is further configured to input the plurality of ratios into a classifier model to obtain a classification result, and determine whether the target object is a living object or not according to the classification result.

In another exemplary embodiment of this application, the apparatus also includes a module configured to execute the following operations:

acquiring a plurality of frames of images of a plurality of living objects, calculating the plurality of ratios according to a plurality of frames of images of each living object in the plurality of living objects, and using the plurality of ratios as a positive sample set;

acquiring a plurality of frames of images of a plurality of non-living objects, calculating the plurality of ratios according to a plurality of frames of images of each non-living object in the plurality of non-living objects, and using the plurality of ratios as a negative sample set; and

acquiring the classifier model using a deep learning algorithm based on based on the positive sample set and the negative sample set.

In another exemplary embodiment of this application, the result determining unit 340 is further configured to: when the classification result is a positive class, determine that the target object is a living object; and when the classification result is a negative class, determine that the target object is a non-living object.

In another exemplary embodiment of this application, the image pick-up unit 310 is further configured to acquire a reference number of frames of images of the target object at different distances to the pick-up camera.

In another exemplary embodiment of this application, the image pick-up unit 310 is further configured to acquire a dynamic image of the target object at a changing position relative to the pick-up camera; and divide the dynamic image according to reference time periods, and extract the reference number of frames of images.

In another exemplary embodiment of this application, the apparatus also includes a module configured to execute the following operations:

prompting by using a detection box a user that an image of the target object appears in the detection box; and

changing a size of the detection box in response to acquiring an image of the target object.

In another exemplary embodiment of this application, the computing unit 330 is further configured to respectively calculate a distance from a pupil point to a nasal tip point, a distance from a pupil point to a mouth corner point and a distance from a mouth corner point to a nasal tip point on each frame of image;

where on each frame of image, the distance from a pupil point to a nasal tip point is a first distance, the distance from a pupil point to a mouth corner point is a second distance, and the distance from a mouth corner point to a nasal tip point is a third distance.

In another exemplary embodiment of this application, the computing unit 330 is further configured to acquire a pupil distance between two eyes on each frame of image; and for the same frame of image, a ratio of the first distance to the pupil distance is a first ratio, a ratio of the second distance to the pupil distance is a second ratio, and a ratio of the third distance to the pupil distance is a third ratio.

In another exemplary embodiment of this application, the result determining unit 340 is further configured to: for the plurality of frames of images, respectively analyze changes in the first ratio, the second ratio and the third ratio.

In another exemplary embodiment of this application, the key point acquiring unit 320 is further configured to: extract the plurality of key points on each frame of image by using a facial landmark localization algorithm.

Since the functional modules of the living body recognition detection apparatus in the exemplary embodiment of this application correspond to the steps in the exemplary embodiment of the above living body recognition detection method, for details not disclosed in the apparatus embodiment of this application, refer to the embodiment of the living body recognition detection method of this application.

FIG. 4 is a schematic structural diagram of a computer system 400 adapted to implement an electronic device according to an embodiment of this application. The computer system 400 of the electronic device shown in FIG. 4 is merely an example, and does not constitute any limitation on functions and use ranges of the embodiments of this application.

As shown in FIG. 4, the computer system 400 includes a central processing unit (CPU) 401, which may perform various proper actions and processing based on a program stored in a read-only memory (ROM) 402 or a program loaded from a storage part 408 into a random access memory (RAM) 403. In the RAM 403, various programs and data necessary for system operations are further stored. The CPU 401, the ROM 402, and the RAM 403 are connected to each other through a bus 404. An input/output (I/O) interface 405 is also connected to the bus 404.

The following components are connected to the I/O interface 405: an input part 406 including a keyboard, a mouse, or the like, an output part 407 including a cathode ray tube (CRT), a liquid crystal display (LCD), a speaker, or the like, a storage part 408 including a hard disk, or the like, and a communication part 409 including a network interface card such as a local area network (LAN) card or a modem. The communication part 409 performs communication processing by using a network such as the Internet. A driver 410 is also connected to the I/O interface 405 as required. A removable medium 411, such as a magnetic disk, an optical disk, a magneto-optical disk, a semiconductor memory or the like, is installed on the drive 410 as needed, so that a computer program read therefrom is installed into the storage part 408 as needed.

Particularly, according to an embodiment of this application, the processes described in the following by referring to the flowcharts may be implemented as computer software programs. For example, an embodiment of this application includes a computer program product. The computer program product includes a computer program stored in a computer-readable medium. The computer program includes a computer program used for performing a method shown in the flowchart. In such an embodiment, by using the communication part 409, the computer program may be downloaded and installed from a network, and/or installed from the removable medium 411. When the computer program is executed by the central processing unit (CPU) 401, the above functions defined in the system of this application are performed.

It should be noted that the computer-readable medium shown in this application may be a computer-readable signal medium or a computer-readable storage medium or any combination of the two. The computer-readable storage medium may be, for example, but not limited to, an electrical, magnetic, optical, electromagnetic, infrared, or semiconductor system, apparatus, or device, or any combination thereof. A more specific example of the computer-readable storage medium may include but is not limited to: an electrical connection having one or more wires, a portable computer magnetic disk, a hard disk, a random access memory (RAM), a read-only memory (ROM), an erasable programmable read-only memory (EPROM or a flash memory), an optical fiber, a compact disk read-only memory (CD-ROM), an optical storage device, a magnetic storage device, or any appropriate combination thereof. In this application, the computer-readable storage medium may be any tangible medium including or storing a program, and the program may be used by or in combination with an instruction execution system, apparatus, or device. In this application, the computer-readable signal medium may include a data signal transmitted in a baseband or as part of a carrier, and stores a computer-readable computer program. The propagated data signal may be in a plurality of forms, including, but not limited to, an electromagnetic signal, an optical signal, or any other appropriate combination thereof. The computer-readable signal medium may be further any computer-readable medium in addition to a computer-readable storage medium. The computer-readable medium may send, propagate, or transmit a program that is used by or used in conjunction with an instruction system, an apparatus, or a device. The program code included in the computer-readable medium may be transmitted by using any suitable medium, including but not limited to, wireless transmission, a wire, a cable, radio frequency (RF) or the like, or any other suitable combination thereof.

The flowcharts and block diagrams in the accompanying drawings illustrate possible system architectures, functions and operations that may be implemented by a system, a method, and a computer program product according to various embodiments of this application. At this point, each block in the flowchart or the block diagram may represent a module, a program segment, or a part of code. The module, the program segment, or the part of code contains one or more executable instructions used for implementing specified logic functions. It should be noted that, in some implementations used as substitutes, functions annotated in boxes may alternatively be occur in a sequence different from that annotated in an accompanying drawing. For example, two blocks represented in succession may be basically executed in parallel, and sometimes may be executed in a reverse order. This depends on related functions. It should also be noted that, each block in the block diagram or the flowchart, and a combination of blocks in the block diagram or the flowchart, may be implemented by using a specific hardware-based system that performs specified functions or operations, or may be implemented by using a combination of special-purpose hardware and computer instructions.

A related unit described in the embodiments of this application may be implemented in a software manner, or may be implemented in a hardware manner, and the unit described can also be set in a processor. Names of the units do not constitute a limitation on the units under certain circumstances.

According to another aspect, this application further provides a computer-readable medium. The computer-readable medium may be included in the electronic device described in the foregoing embodiments, or may exist alone and is not assembled in the electronic device. The computer-readable medium carries one or more programs, the one or more programs, when executed by the electronic device, causing the electronic device to implement the living body recognition detection method described in the foregoing embodiments.

For example, the electronic device may implement the following steps shown in FIG. 1: step S110, acquiring a plurality of frames of images of a target object at different positions relative to a pick-up camera; step S120, extracting a plurality of key points on each frame of image in the plurality of frames of images; step S130, respectively calculating distances between the key points on each frame of image, and calculating a plurality of ratios of each frame of image according to the calculated distances of each frame of image; and step S140, analyzing changes of the plurality of ratios for the plurality of frames of images, and determining whether the target object is a living object or not according to the changes of the plurality of ratios.

In another example, the electronic device may implement the steps shown in FIG. 2.

Although several modules or units of the device for action execution are mentioned in the foregoing detailed description, such a division is not mandatory. In fact, the features and the functions of two or more modules or units described above may be embodied in one module or unit according to the implementations of this application. On the other hand, the features and the functions of one module or unit described above may be further divided into a plurality of modules or units to be embodied.

Through descriptions of the foregoing implementations, it is easy for a person skilled in the art to understand that the exemplary implementations described herein can be implemented by software or by combining software with necessary hardware. Therefore, the technical solutions of the implementations of this application may be implemented in a form of a software product. The software product may be stored in a non-volatile storage medium (which may be a CD-ROM, a USB flash drive, a removable hard disk, or the like) or on a network, and includes several instructions for instructing a computing device (which may be a personal computer, a server, a touch terminal, network device, or the like) to perform the methods according to the implementations of this application.

Other embodiments of this specification will be apparent to a person skilled in the art from consideration of the specification and practice of the present application disclosed here. This application is intended to cover any variation, use, or adaptive change of this application. These variations, uses, or adaptive changes follow the general principles of this application and include common general knowledge or common technical means in the art that are not disclosed in this application. The specification and the embodiments are considered as merely exemplary, and the real scope and spirit of this application are pointed out in the following claims.

It should be understood that this application is not limited to the precise structures described above and shown in the accompanying drawings, and various modifications and changes can be made without departing from the scope of this application. The scope of this application is limited by the appended claims only.

According to an aspect of the embodiments of this application, a living object recognition method is provided, including:

acquiring a plurality of frames of images of a target object at different positions relative to a pick-up camera;

extracting a plurality of key points on each frame of image in the plurality of frames of images;

respectively calculating distances between the key points on each frame of image, and calculating a plurality of ratios of each frame of image according to the calculated distances of each frame of image; and

analyzing changes of the plurality of ratios for the plurality of frames of images, and determining whether the target object is a living object or not according to the changes of the plurality of ratios.

In an exemplary embodiment of this application, based on the preceding solution, the step of determining whether the target object is a living object or not according to the changes of the plurality of ratios includes:

inputting the plurality of ratios into a classifier model to obtain a classification result, and determining whether the target object is a living object or not according to the classification result.

In an exemplary embodiment of this application, based on the preceding solution, before the step of inputting the plurality of ratios into a classifier model, the method further includes:

acquiring a plurality of frames of images of a plurality of living objects, calculating the plurality of ratios according to a plurality of frames of images of each living object in the plurality of living objects, and using the plurality of ratios as a positive sample set;

acquiring a plurality of frames of images of a plurality of non-living objects, calculating the plurality of ratios according to a plurality of frames of images of each non-living object in the plurality of non-living objects, and using the plurality of ratios as a negative sample set; and

acquiring the classifier model using a deep learning algorithm based on based on the positive sample set and the negative sample set.

In an exemplary embodiment of this application, based on the preceding solution, the step of determining whether the target object is a living object or not according to the classification result includes:

when the classification result is a positive class, determining that the target object is a living object; and

when the classification result is a negative class, determining that the target object is a non-living object.

In an exemplary embodiment of this application, based on the preceding solution, the step of acquiring a plurality of frames of images of a target object at different positions relative to a pick-up camera includes:

acquiring a reference number of frames of images of the target object at different distances to the pick-up camera.

In an exemplary embodiment of this application, based on the preceding solution, the step of acquiring a plurality of frames of images of a target object at different positions relative to a pick-up camera includes:

acquiring a dynamic image of the target object at a changing position relative to the pick-up camera; and

dividing the dynamic image according to reference time periods, and extracting the reference number of frames of images.

In an exemplary embodiment of this application, based on the preceding solution, the method further includes:

prompting by using a detection box a user that an image of the target object appears in the detection box; and

changing a size of the detection box in response to acquiring an image of the target object.

In an exemplary embodiment of this application, based on the preceding solution, the step of respectively calculating distances between the key points on each frame of image includes:

respectively calculating a distance from a pupil point to a nasal tip point, a distance from a pupil point to a mouth corner point and a distance from a mouth corner point to a nasal tip point on each frame of image;

where on each frame of image, the distance from a pupil point to a nasal tip point is a first distance, the distance from a pupil point to a mouth corner point is a second distance, and the distance from a mouth corner point to a nasal tip point is a third distance.

In an exemplary embodiment of this application, based on the preceding solution, the step of calculating a plurality of ratios of each frame of image according to the calculated distances of each frame of image includes:

acquiring a pupil distance between two eyes on each frame of image; and

for the same frame of image, calculating a ratio of the first distance to the pupil distance as a first ratio, calculating a ratio of the second distance to the pupil distance as a second ratio, and calculating a ratio of the third distance to the pupil distance as a third ratio, so as to obtain the first ratio, the second ratio and the third ratio of each frame of image.

In an exemplary embodiment of this application, based on the preceding solution, the step of analyzing changes of the plurality of ratios for the plurality of frames of images includes:

for the plurality of frames of images, respectively analyzing changes in the first ratio, the second ratio and the third ratio.

In an exemplary embodiment of this application, based on the preceding solution, the step of extracting a plurality of key points on each frame of image in the plurality of frames of images includes:

extracting the plurality of key points on each frame of image by using a facial landmark localization algorithm.

According to another aspect of the embodiments of this application, a living object recognition apparatus is provided, including:

an image pick-up unit, configured to acquire a plurality of frames of images of a target object at different positions relative to a pick-up camera;

a key point acquiring unit, configured to extract a plurality of key points on each frame of image in the plurality of frames of images;

a computing unit, configured to respectively calculate distances between the key points on each frame of image, and calculate a plurality of ratios of each frame of image according to the calculated distances of each frame of image; and

a result determining unit, configured to analyze changes of the plurality of ratios for the plurality of frames of images, and determine whether the target object is a living object or not according to the changes of the plurality of ratios.

According to yet another aspect of the embodiments of this application, a non-volatile computer readable medium is provided, storing a computer program therein, where when executed by a processor, the program implements the living object recognition method, the method including:

acquiring a plurality of frames of images of a target object at different positions relative to a pick-up camera;

extracting a plurality of key points on each frame of image in the plurality of frames of images;

respectively calculating distances between the key points on each frame of image, and calculating a plurality of ratios of each frame of image according to the calculated distances of each frame of image; and

analyzing changes of the plurality of ratios for the plurality of frames of images, and determining whether the target object is a living object or not according to the changes of the plurality of ratios.

According to yet another aspect of the embodiments of this application, an electronic device is provided, including: one or more processors; and a storage apparatus configured to store one or more programs that, when executed by the one or more processors, cause the one or more processors to implement the following operations:

acquiring a plurality of frames of images of a target object at different positions relative to a pick-up camera;

extracting a plurality of key points on each frame of image in the plurality of frames of images;

respectively calculating distances between the key points on each frame of image, and calculating a plurality of ratios of each frame of image according to the calculated distances of each frame of image; and

analyzing changes of the plurality of ratios for the plurality of frames of images, and determining whether the target object is a living object or not according to the changes of the plurality of ratios.

In an exemplary embodiment of this application, based on the preceding solution, the one or more programs, when executed by the one or more processors, further cause the one or more processors to implement the following operations:

inputting the plurality of ratios into a classifier model to obtain a classification result, and determining whether the target object is a living object or not according to the classification result.

In an exemplary embodiment of this application, based on the preceding solution, the one or more programs, when executed by the one or more processors, further cause the one or more processors to implement the following operations:

acquiring a plurality of frames of images of a plurality of living objects, calculating the plurality of ratios according to a plurality of frames of images of each living object in the plurality of living objects, and using the plurality of ratios as a positive sample set;

acquiring a plurality of frames of images of a plurality of non-living objects, calculating the plurality of ratios according to a plurality of frames of images of each non-living object in the plurality of non-living objects, and using the plurality of ratios as a negative sample set; and

acquiring the classifier model using a deep learning algorithm based on based on the positive sample set and the negative sample set.

In an exemplary embodiment of this application, based on the preceding solution, the one or more programs, when executed by the one or more processors, further cause the one or more processors to implement the following operations:

when the classification result is a positive class, determining that the target object is a living object; and

when the classification result is a negative class, determining that the target object is a non-living object.

In an exemplary embodiment of this application, based on the preceding solution, the one or more programs, when executed by the one or more processors, further cause the one or more processors to implement the following operations:

acquiring a reference number of frames of images of the target object at different distances to the pick-up camera.

In an exemplary embodiment of this application, based on the preceding solution, the one or more programs, when executed by the one or more processors, further cause the one or more processors to implement the following operations:

acquiring a dynamic image of the target object at a changing position relative to the pick-up camera; and

dividing the dynamic image according to reference time periods, and extracting the reference number of frames of images.

In an exemplary embodiment of this application, based on the preceding solution, the one or more programs, when executed by the one or more processors, further cause the one or more processors to implement the following operations:

prompting by using a detection box a user that an image of the target object appears in the detection box; and

changing a size of the detection box in response to acquiring an image of the target object.

In an exemplary embodiment of this application, based on the preceding solution, the one or more programs, when executed by the one or more processors, further cause the one or more processors to implement the following operations:

respectively calculating a distance from a pupil point to a nasal tip point, a distance from a pupil point to a mouth corner point and a distance from a mouth corner point to a nasal tip point on each frame of image;

where on each frame of image, the distance from a pupil point to a nasal tip point is a first distance, the distance from a pupil point to a mouth corner point is a second distance, and the distance from a mouth corner point to a nasal tip point is a third distance.

In an exemplary embodiment of this application, based on the preceding solution, the one or more programs, when executed by the one or more processors, further cause the one or more processors to implement the following operations:

acquiring a pupil distance between two eyes on each frame of image; and

for the same frame of image, a ratio of the first distance to the pupil distance is a first ratio, a ratio of the second distance to the pupil distance is a second ratio, and a ratio of the third distance to the pupil distance is a third ratio.

In an exemplary embodiment of this application, based on the preceding solution, the one or more programs, when executed by the one or more processors, further cause the one or more processors to implement the following operations:

for the plurality of frames of images, respectively analyzing changes in the first ratio, the second ratio and the third ratio.

In an exemplary embodiment of this application, based on the preceding solution, the one or more programs, when executed by the one or more processors, further cause the one or more processors to implement the following operations:

extracting the plurality of key points on each frame of image by using a facial landmark localization algorithm.

1. A living body recognition detection method, comprising:
acquiring a plurality of frames of images of a target object at different positions relative to a pick-up camera;
extracting a plurality of key points on each frame of image in the plurality of frames of images;
respectively calculating distances between the key points on each frame of image, and calculating a plurality of ratios of each frame of image according to the calculated distances of each frame of image; and
analyzing changes of the plurality of ratios for the plurality of frames of images, and determining whether the target object is a living object or not according to the changes of the plurality of ratios.

2. The living body recognition detection method according to claim 1, wherein the step of determining whether the target object is a living object or not according to the changes of the plurality of ratios comprises:
inputting the plurality of ratios into a classifier model to obtain a classification result, and determining whether the target object is a living object or not according to the classification result.

3. The living body recognition detection method according to claim 2, wherein before the step of inputting the plurality of ratios into a classifier model, the method further comprises:
acquiring a plurality of frames of images of a plurality of living objects, calculating the plurality of ratios according to a plurality of frames of images of each living object in the plurality of living objects, and using the plurality of ratios as a positive sample set;
acquiring a plurality of frames of images of a plurality of non-living objects, calculating the plurality of ratios according to a plurality of frames of images of each non-living object in the plurality of non-living objects, and using the plurality of ratios as a negative sample set; and
acquiring the classifier model using a deep learning algorithm based on based on the positive sample set and the negative sample set.

4. The living body recognition detection method according to claim 2, wherein the step of determining whether the target object is a living object or not according to the classification result comprises:
when the classification result is a positive class, determining that the target object is a living object; and
when the classification result is a negative class, determining that the target object is a non-living object.

5. The living body recognition detection method according to claim 1, wherein the step of acquiring a plurality of frames of images of a target object at different positions relative to a pick-up camera comprises:
acquiring a reference number of frames of images of the target object at different distances to the pick-up camera.

6. The living body recognition detection method according to claim 5, wherein the step of acquiring a plurality of frames of images of a target object at different positions relative to a pick-up camera comprises:
acquiring a dynamic image of the target object at a changing position relative to the pick-up camera; and
dividing the dynamic image according to reference time periods, and extracting the reference number of frames of images.

7. The living body recognition detection method according to claim 5, further comprising:
prompting by using a detection box a user that an image of the target object appears in the detection box; and
changing a size of the detection box in response to acquiring an image of the target object.

8. The living body recognition detection method according to claim 1, wherein the step of respectively calculating distances between the key points on each frame of image comprises:
respectively calculating a distance from a pupil point to a nasal tip point, a distance from a pupil point to a mouth corner point and a distance from a mouth corner point to a nasal tip point on each frame of image;
wherein on each frame of image, the distance from a pupil point to a nasal tip point is a first distance, the distance from a pupil point to a mouth corner point is a second distance, and the distance from a mouth corner point to a nasal tip point is a third distance.

9. The living body recognition detection method according to claim 8, wherein the step of calculating a plurality of ratios of each frame of image according to the calculated distances of each frame of image comprises:
acquiring a pupil distance between two eyes on each frame of image; and
for the same frame of image, a ratio of the first distance to the pupil distance is a first ratio, a ratio of the second distance to the pupil distance is a second ratio, and a ratio of the third distance to the pupil distance is a third ratio.

10. The living body recognition detection method according to claim 9, wherein the step of analyzing changes of the plurality of ratios for the plurality of frames of images comprises:
for the plurality of frames of images, respectively analyzing changes in the first ratio, the second ratio and the third ratio.

11. The living body recognition detection method according to claim 1, wherein the step of extracting a plurality of key points on each frame of image in the plurality of frames of images comprises:
extracting the plurality of key points on each frame of image by using a facial landmark localization algorithm.

12. (canceled)

13. A non-volatile computer readable medium storing a computer program thereon, wherein when executed by a processor, the program implements a living body recognition detection method, the method comprising:
acquiring a plurality of frames of images of a target object at different positions relative to a pick-up camera;
extracting a plurality of key points on each frame of image in the plurality of frames of images;
respectively calculating distances between the key points on each frame of image, and calculating a plurality of ratios of each frame of image according to the calculated distances of each frame of image; and
analyzing changes of the plurality of ratios for the plurality of frames of images, and determining whether the target object is a living object or not according to the changes of the plurality of ratios.

14. An electronic device, comprising:
one or more processors; and
a storage apparatus configured to store one or more programs that, when executed by the one or more processors, cause the one or more processors to implement the following operations:
acquiring a plurality of frames of images of a target object at different positions relative to a pick-up camera;
extracting a plurality of key points on each frame of image in the plurality of frames of images;
respectively calculating distances between the key points on each frame of image, and calculating a plurality of ratios of each frame of image according to the calculated distances of each frame of image; and
analyzing changes of the plurality of ratios for the plurality of frames of images, and determining whether the target object is a living object or not according to the changes of the plurality of ratios.

15. The electronic device according to claim 14, wherein the one or more programs, when executed by the one or more processors, further cause the one or more processors to implement the following operations:
inputting the plurality of ratios into a classifier model to obtain a classification result, and determining whether the target object is a living object or not according to the classification result.

16. The electronic device according to claim 15, wherein the one or more programs, when executed by the one or more processors, further cause the one or more processors to implement the following operations:
acquiring a plurality of frames of images of a plurality of living objects, calculating the plurality of ratios according to a plurality of frames of images of each living object in the plurality of living objects, and using the plurality of ratios as a positive sample set;
acquiring a plurality of frames of images of a plurality of non-living objects, calculating the plurality of ratios according to a plurality of frames of images of each non-living object in the plurality of non-living objects, and using the plurality of ratios as a negative sample set; and
acquiring the classifier model using a deep learning algorithm based on the positive sample set and the negative sample set.

17. The electronic device according to claim 15, wherein the one or more programs, when executed by the one or more processors, further cause the one or more processors to implement the following operations:
when the classification result is a positive class, determining that the target object is a living object; and
when the classification result is a negative class, determining that the target object is a non-living object.

18. The electronic device according to claim 14, wherein the one or more programs, when executed by the one or more processors, further cause the one or more processors to implement the following operations:
acquiring a reference number of frames of images of the target object at different distances to the pick-up camera.

19. The electronic device according to claim 18, wherein the one or more programs, when executed by the one or more processors, further cause the one or more processors to implement the following operations:
acquiring a dynamic image of the target object at a changing position relative to the pick-up camera; and
dividing the dynamic image according to reference time periods, and extracting the reference number of frames of images.

20. The electronic device according to claim 18, wherein the one or more programs, when executed by the one or more processors, further cause the one or more processors to implement the following operations:
prompting by using a detection box a user that an image of the target object appears in the detection box; and
changing a size of the detection box in response to acquiring an image of the target object.

21. The electronic device according to claim 14, wherein the one or more programs, when executed by the one or more processors, further cause the one or more processors to implement the following operations:
respectively calculating a distance from a pupil point to a nasal tip point, a distance from a pupil point to a mouth corner point and a distance from a mouth corner point to a nasal tip point on each frame of image;
wherein on each frame of image, the distance from a pupil point to a nasal tip point is a first distance, the distance from a pupil point to a mouth corner point is a second distance, and the distance from a mouth corner point to a nasal tip point is a third distance.

22-24. (canceled)
